(19) United States
(12) Patent Application Publication
(10) Pub. No.: US 2025/0147726 A1
(43) Pub. Date: May 8, 2025

(54) METHODS FOR AND DEVICES THEREOF FOR GENERATING A DENOISED DATA SET

(71) Applicant: CURIA IP HOLDINGS, LLC, Albany, NY (US)

(72) Inventor: Richard B. McClurg, Albany, NY (US)

(21) Appl. No.: 18/936,580

(22) Filed: Nov. 4, 2024

Related U.S. Application Data
(60) Provisional application No. 63/596,061, filed on Nov. 3, 2023.

(51) Int. Cl. G06F 7/50

(52) U.S. Cl. CPC G06F 7/50

(57) ABSTRACT

A method for generating a denoised data set from a data set comprising a signal and Poisson noise is disclosed. The method includes applying, by a data set denoising computing device, a Haar transform to the data set to generate a Haar transformed data set. The Haar transformed data set is denoised using a thresholding rule based on the Haar transformed data set to remove the Poisson noise from the signal. A reverse Haar transform is applied to the denoised Haar transformed data set to generate the denoised data set. A data set denoising computing device and non-transitory computer readable medium for performing the method are also disclosed.

This application claims the benefit of U.S. Provisional Patent Application Ser. No. 63/596,061, filed Nov. 3, 2023, which is hereby incorporated by reference in its entirety.

### BACKGROUND

FIG. 1 illustrates a portion of a diffraction pattern that contains four peaks indicative of a crystalline component, Mannitol form beta. Background scattering of approximately 100 counts per bin throughout the pattern is the result of air scattering in the diffractometer, scattering from the sample holder, Compton scattering, and other diffuse scattering sources. Both the peaks and the background scattering are collectively referred to as the signal. Noise is evident as variability in the signal, particularly for the background though noise is also present in the peaks.

Poisson noise, also called counting noise or shot noise, refers to the fluctuations in the count of discrete and independent events with a constant mean arrival rate. X-ray diffraction provides an excellent illustration of Poisson noise. Photon arrivals at the detector are the discrete and independent events. The mean arrival rate in a chosen range of diffraction angles is fixed assuming that the X-ray source, diffractometer, specimen, and detector are unchanged during the analysis. Although the expectation value for the number of arrivals in a chosen range and duration is fixed, repeated scans lead to a distribution of observed arrival counts because the photons arrivals are uncorrelated. The average of the distribution is the expectation value for the number of photons in the selected diffraction angle range and duration, also called the signal. Deviations from the expectation value are Poisson noise.

The signal-to-noise ratio for diffraction data may be improved by counting more photons since the magnitude of the Poisson noise is proportional to the square root of the signal in each bin. Higher intensity X-ray sources can be used, but the source is generally considered fixed once the diffractometer has been acquired. Longer analysis times can be employed, but at the expense of reduced sample throughput for the diffractometer. There is also a trade-off between the use of narrow diffractometer slits and/or narrow band-pass monochromators to improve peak resolution at the expense of poorer signal-to-noise characteristics. For situations in which high intensity sources are available for extended periods, experimental methods can be selected to collect data with excellent signal-to-noise and peak resolution for a particular sample. If sample throughput is a consideration, then there is necessarily a trade-off between collecting more photons for a particular sample to improve the characteristics of its diffraction pattern and analyzing more samples.

For a given set of experimental data, one may attempt to process the data such that signals are preserved but noise is reduced. This procedure is called denoising. Common methods for smoothing data are not well suited to diffraction data that may contain both signals of various breadths and Poisson noise.

Digital filters smooth data by replacing noisy data with a local average of nearby data points. The number of data points that contribute to the estimate for a particular data point is called the filter width. Moving average filtering, also called rolling window filtering, works well for data that can be approximated as linear over the width of the filter, but tends to reduce the maximum intensity and broaden sharp peaks. Savitsky-Golay filtering works best for data that can be approximated as a low-order polynomial over the width of the filter. Features that are broader than the filter width are under-smoothed and sharper features are broadened by the smoothing process. Both moving average and Savitsky-Golay filters are based on the assumption of independent and identically distributed (IID) noise which can lead to inaccurate results for data with Poisson noise which is inherently heteroskedastic, with larger variance for larger signals.

Fourier analysis has also been used for denoising. Low-pass digital filters work best for smooth, low frequency signals with high frequency noise so that the signal and noise may be separated using a Wiener filter, for instance. The Fourier representation of sharp peaks has a broad range in frequency space according to the uncertainty principle. This makes separation of the noise difficult in patterns containing sharp signal peaks. Application of a Wiener filter to denoise data with sharp peaks leads to removal of the high-frequency components needed to accurately represent the sharp peaks. Without these components, an undershoot on either side of each peak and long-range ringing artifacts in the denoised signal are the result. Both of these results are undesirable. The problem with using Fourier methods to denoise data containing sharp peaks is the use of a basis set composed of sines and cosines, which have discrete frequencies but no localization, to model diffraction peaks which are localized with a wide frequency support. This mismatch between the basis functions and the data is at the core of the difficulty in applying Fourier denoising to diffraction data.

Wavelets provide an alternative to the Fourier basis. Wavelets are a category of bases that are localized in both space and frequency. Denoising using wavelets yields a sparse representation of data with localized peaks. In the transformed space, coefficients for basis functions localized near peak locations are relatively large whereas coefficients corresponding to basis functions that are localized between peaks are indistinguishable from noise and can be safely set to zero. In order to implement wavelet-based denoising, one must select both a wavelet basis and a criterion for determining which coefficients are small enough in magnitude to disregard. The criterion is called a thresholding rule. The denoised data is then reconstructed using the inverse wavelet transform.

While wavelets have been employed for denoising powder diffraction data, such applications utilized a threshold rule that uses the median of the details vector to estimate the noise standard deviation. Using the median value of the details vector to estimate a single standard deviation for the noise implicitly assumes that the noise is drawn from a distribution with a fixed standard deviation. This assumption is incorrect for count data with Poisson noise.

The present disclosure is directed to overcoming these and other deficiencies in the art.

### SUMMARY

A method for generating a denoised data set from a data set comprising a signal and Poisson noise is disclosed. The method includes applying, by a data set denoising computing device, a Haar transform to the data set to generate a Haar transformed data set. The Haar transformed data set is denoised using a thresholding rule based on the Haar transformed data set to remove the Poisson noise from the signal. A reverse Haar transform is applied to the denoised Haar transformed data set to generate the denoised data set. A data set denoising computing device and non-transitory computer readable medium for performing the method are also disclosed.

The present disclosure provides methods and devices for denoising data sets, such as powder diffraction patterns, comprised of count data with Poisson noise over evenly spaced intervals. The methods and devices can further be employed to denoise two-dimensional image data. The disclosed method uses Haar wavelet transforms and a hard thresholding rule designed specifically for the Poisson noise distribution, although in other examples a soft thresholding rule could be employed. Cycle spinning of the transform significantly improves the results. The method utilizes an algorithm that contains two parameters: a cut-off value for the hard thresholding rule and a cycle spinning depth. The results of the disclosed denoising method are insensitive to the precise value of the cut-off value such that a consistent value is adequate. A procedure for determining the necessary cycle spinning depth based on the results of the first transform cycle is also disclosed.

The disclosed method is numerically efficient and limits the computational time and power required. Position and shapes of features in the data set are preserved. The method further preserves patterns in the signals and dramatically reduces noise. The method further reduces collection time of scans and can be used to optimize the appearance of a data set, such as diffraction pattern or two-dimensional image.

### BRIEF DESCRIPTION OF THE DRAWINGS

FIG. 1 illustrates a portion of a typical diffraction pattern illustrating diffraction peaks, background scattering, and Poisson noise.

FIG. 2 is a block diagram of an environment including an exemplary data set denoising computing device according to aspects of the present disclosure.

FIG. 3 is a block diagram of an exemplary data set denoising computing device according to aspects of the present disclosure.

FIG. 4 is a flowchart of an exemplary method of denoising a data set according to aspects of the present disclosure.

FIG. 5 illustrates an exemplary schematic histogram representation of the probability density function for a diffraction pattern according to aspects of the present disclosure.

FIG. 6 illustrates an exemplary Haar basis scale function (φ), mother function (ψ₀), and daughter functions (ψᵢ) according to aspects of the present disclosure.

FIG. 7 illustrates a schematic of an exemplary Haar transform and inverse transform according to aspects of the present disclosure.

FIG. 8 illustrates an exemplary test diffraction pattern prior to scaling and noise addition according to aspects of the present disclosure.

FIGS. 9A-9C illustrate exemplary synthetic patterns with Poisson noise for three scale factor values according to aspects of the present disclosure.

FIG. 10A-10F illustrate weighted-pattern residual (R_{wp}) values computed using the difference between the (known) scaled test pattern (I₀) and the denoised pattern (I) both with and without cycle spinning, for six choices of scale factor (10 to 10⁶) and five independent synthetic noise repetitions (colors).

FIGS. 11A-11C illustrate an exemplary noisy pattern (FIG. 11A), denoised pattern (FIG. 11B), and a denoised spin-cycled pattern (FIG. 11C) for the exemplary synthetic pattern shown in FIG. 8 at the scale factor shown in FIG. 9B.

FIGS. 12A-12C illustrate denoised and spin-cycled patterns corresponding to the input patterns shown in FIGS. 9A-9C.

FIG. 13A illustrates experimental diffraction data collected on a monolithic specimen of alpha alumina.

FIG. 13B illustrates the experimental diffraction data of FIG. 13A denoised using cycle spinning according to aspects of the present disclosure.

FIG. 14A illustrates experimental diffraction data collected on a powder specimen of mannitol form beta.

FIG. 14B illustrates the experimental diffraction data of FIG. 14A denoised using cycle spinning according to aspects of the present disclosure.

FIG. 15A illustrates experimental diffraction data collected on a powder specimen of lyophilized trehalose.

FIG. 15B illustrates the experimental diffraction data of FIG. 15A denoised using cycle spinning according to aspects of the present disclosure.

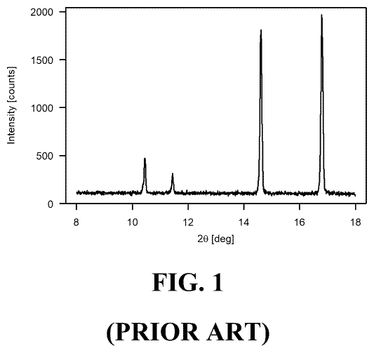

### DETAILED DESCRIPTION

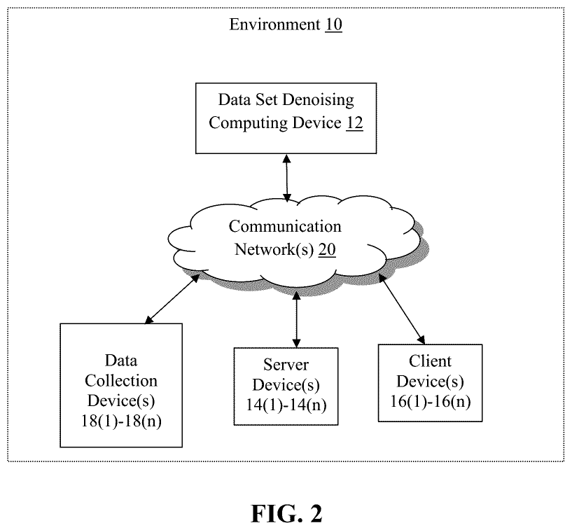

Referring to FIG. 2, an exemplary environment 10 that incorporates an exemplary data set denoising computing device 12 is illustrated. The data set denoising computing device 102 is coupled to server devices 14(1)-14(n), client devices 16(1)-16(n), and data collection devices 18(1)-18(n) via communication network(s) 20, although the data set denoising computing device 10, server devices 14(1)-14(n), client devices 16(1)-16(n), and data collection devices 18(1)-18(n) may be coupled together via other topologies. This technology provides a number of advantages including methods, non-transitory computer readable media, and data set denoising computing devices that denoise data sets, such as powder diffraction patterns, comprised of count data with Poisson noise over evenly spaced intervals in a numerically efficient, computationally limited manner that preserves patterns in the signals and dramatically reduces noise.

In this particular example, the data set denoising computing device 12, server devices 14(1)-14(n), client devices 16(1)-16(n), and data collection devices 18(1)-18(n) are disclosed in FIG. 2 as dedicated hardware devices. However, one or more of the data set denoising computing device 12, server devices 14(1)-14(n), client devices 16(1)-16(n), or data collection devices 18(1)-18(n) can also be implemented in software within one or more other devices in the environment 10.

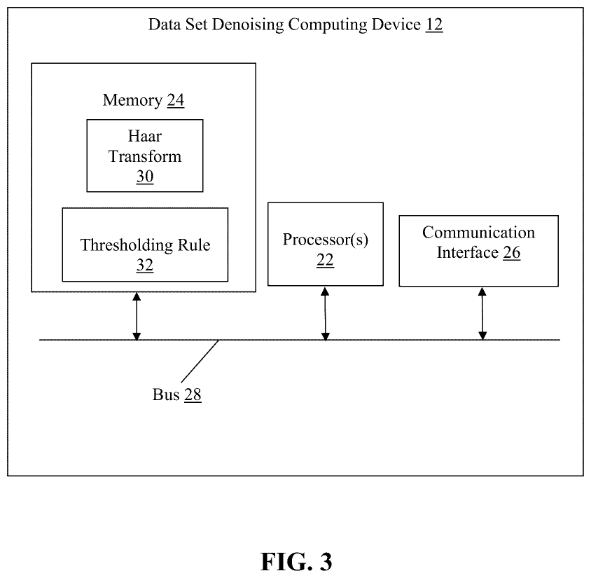

Referring to FIGS. 2 and 3, the data set denoising computing device 12 may be employed for denoising data sets, such as powder diffraction patterns or two-dimensional image data. The data set denoising computing device 12 in this example includes one or more processor(s) 22, a memory 24, and a communication interface 26, which are coupled together by a bus 28, although the data set denoising computing device 12 can include other types or numbers of elements in other configurations.

The processor(s) of the data set denoising computing device 12 may execute programmed instructions stored in the memory of the data set denoising computing device 102 for any number of the functions identified above. The processor(s) 22 of the data set denoising computing device 12 may include one or more central processing units (CPUs) or general purpose processors with one or more processing cores, for example, although other types of processor(s) 22 can also be used.

The memory 24 of the data set denoising computing device 12 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 22, can be used for the memory 24.

Accordingly, the memory 24 of the data set denoising computing device 12 can store one or more modules that can include computer executable instructions that, when executed by the data set denoising computing device, cause the data set denoising computing device 12 to perform actions described herein. The modules can be implemented as components of other modules. Further, the modules can be implemented as applications, operating system extensions, plugins, or the like.

Even further, the modules may be operative in a cloud-based computing environment. The modules can be executed within or as virtual machine(s) or virtual server(s) that may be managed in a cloud-based computing environment. Also, the modules, and even the data set denoising computing device 12 itself, may be located in virtual server(s) running in a cloud-based computing environment rather than being tied to one or more specific physical network computing devices. Also, the modules may be running in one or more virtual machines (VMs) executing on the data set denoising computing device. Additionally, in one or more examples of this technology, virtual machine(s) running on the data set denoising computing device 12 may be managed or supervised by a hypervisor. In this particular example, the memory 24 of the data set denoising computing device 12 includes a Haar transform 30 and a thresholding rule 32 for performing the denoising method of the present disclosure.

Referring back to FIGS. 2 and 3, the communication interface 26 of the data set denoising computing device 12 operatively couples and communicates between the data set denoising computing device 12, server devices 14(1)-14(n), client devices 16(1)-16(n), and data collection devices 18(1)-18(n) which are coupled together at least in part by the communication network(s) 20, although other types or numbers of communication networks or systems with other types or numbers of connections or configurations to other devices or elements can also be used.

By way of example only, the communication network(s) 20 can include local area network(s) (LAN(s)) or wide area network(s) (WAN(s)), and can use TCP/IP over Ethernet and industry-standard protocols, although other types or numbers of protocols or communication networks can be used. The communication network(s) 20 in this example can employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

While the data set denoising computing device 12 is illustrated in this example as including a single device, the data set denoising computing device 12 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the data set denoising computing device.

Additionally, one or more of the devices that together comprise the data set denoising computing device 12 in other examples can be standalone devices or integrated with one or more other devices or apparatuses, such as one or more of the server devices, for example. Moreover, one or more of the devices of the data set denoising computing device 12 in these examples can be in a same or a different communication network including one or more public, private, or cloud networks, for example.

Each of the server devices 14(1)-14(n) in this example includes processor(s), a memory, and a communication interface, which are coupled together by a bus or other communication link, although other numbers or types of components could be used. The server devices 14(1)-14(n) in this example can include application servers, database servers, or access control servers, for example, although other types of server devices can also be included in the environment 10.

The client devices 16(1)-16(n) in this example include any type of computing device, such as mobile, desktop, laptop, or tablet computing devices, virtual machines (including cloud-based computers), or the like. Each of the client devices 16(1)-16(n) in this example includes a processor, a memory, and a communication interface, which are coupled together by a bus or other communication link (not illustrated), although other numbers or types of components could also be used.

The client devices 16(1)-16(n) may run interface applications, such as standard web browsers or standalone client applications, which may provide an interface to make requests for, and receive content stored on, one or more of the server devices via the communication network(s). The client devices 16(1)-16(n) may further include a display device, such as a display screen or touchscreen, or an input device, such as a keyboard for example (not illustrated).

Although the exemplary environment 10 with the data set denoising computing device 12, server devices 14(1)-14(n), client devices 16(1)-16(n), data collection devices 18(1)-18(n), and communication network(s) 20 are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the environment 10, such as the data set denoising computing device 12, server devices 14(1)-14(n), client devices 16(1)-16(n), or data collection devices 18(1)-18(n), for example, may be configured to operate as virtual instances on the same physical machine. In other words, one or more of the data set denoising computing device 12, server devices 14(1)-14(n), client devices 16(1)-16(n), or data collection devices 18(1)-18(n) may operate on the same physical device rather than as separate devices communicating through communication network(s). Additionally, there may be more or fewer data set denoising computing devices 12, client devices 14(1)-14(n), server devices 16(1)-16(n), or data collection devices 18(1)-18(n) than illustrated in FIG. 2.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only, wireless traffic networks, cellular traffic networks, Packet Data Networks (PDNs), the Internet, intranets, and combinations thereof.

The examples may also be embodied as one or more non-transitory computer readable media having instructions stored thereon, such as in the memory of the data set denoising computing device, for one or more aspects of the present technology, as described and illustrated by way of the examples herein. The instructions in some examples include executable code that, when executed by one or more processors, such as the processor(s) of the data set denoising computing device, cause the processors to carry out steps necessary to implement the methods of the examples of this technology that are described and illustrated herein.

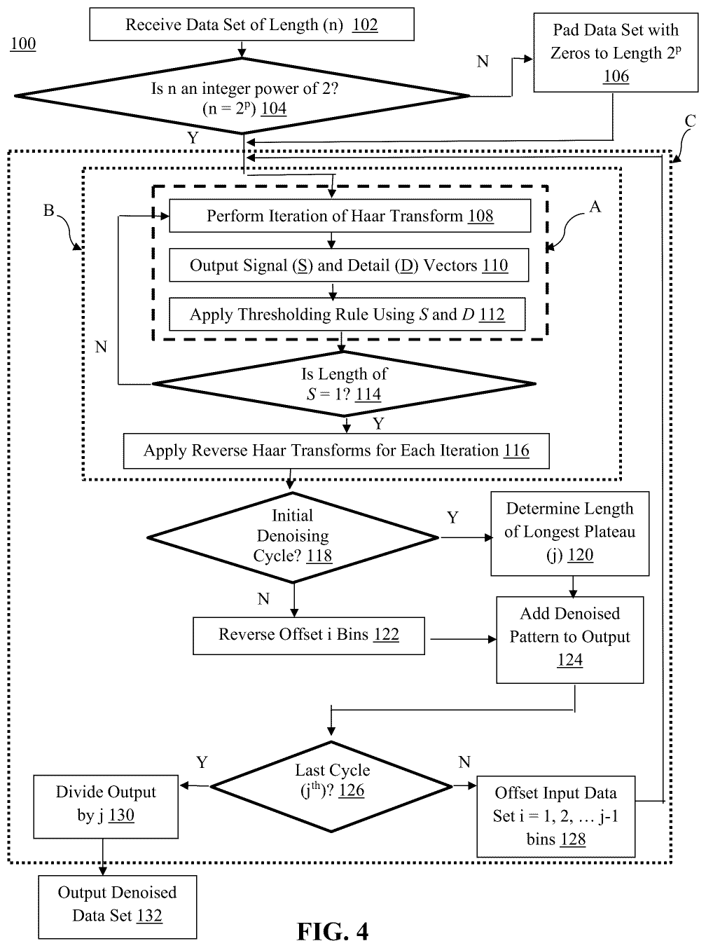

Referring more specifically to FIG. 4, a flowchart of an exemplary method 100 of denoising a data set is illustrated. In a first step 102 in this example, the data set denoising computing device 12 receives a data set, such as a diffraction pattern. The data set can be received from any of the server devices 14(1)-14(n), client devices 16(1)-16(n), or data collection devices 18(1)-18(n) shown in FIG. 2, by way of example.

In the next step 104, the data set denoising computing device 12 determines if the data set, which is a vector of length n, has a length n that is an integer power of 2 (i.e., n=2^{p}). If yes, the Y branch is taken and the method continues. If no, the N branch is taken and in step 106, the data set is padded with zeros to meet the condition n=2^{p} and the method continues.

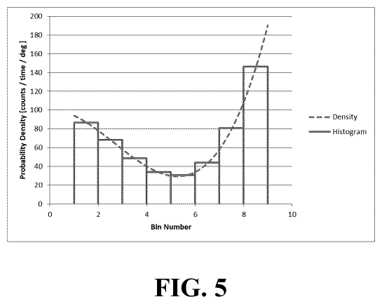

In one example, the data set is a diffraction pattern, although the disclosed methods can be used with other data sets, such as two-dimensional image data. Consider a diffraction pattern collected as a function of Bragg angle (2θ) with constant step size (Δ2θ) and collection time per step (Δt). Then the expectation value for the count of X-rays (Î) is given by equation (1) below:

$$\hat{I} = {I}_{s} Δ t {\int }_{2 θ - \frac{Δ 2 θ}{2}}^{2 θ + \frac{Δ 2 θ}{2}} ρ dx \qquad ( 1 )$$

where ρ is the probability density per unit angle that each independent X-ray photon leaving the source with intensity Iₛ is detected in a bin centered at 2θ. This probability density is determined by both the specimen and the diffractometer optics. Thus, a single value is used to represent the average of a continuous function (ρ) in a narrow region centered on the Bragg angle (2θ). This is a histogram as illustrated in FIG. 5. The dashed curve is the probability density function for the arrival of an X-ray per unit time and collection interval (ρ Δt Δ2θ). The histogram shows the expectation value for the number of X-rays collected in the illustrated step size during the same time interval. Since there are many narrow bins in a typical diffraction pattern, it is common practice to present diffraction data using a line plot with vertices at the midpoints of the top of each bin, but this presentation does not change the fact that powder diffraction patterns are fundamentally histograms.

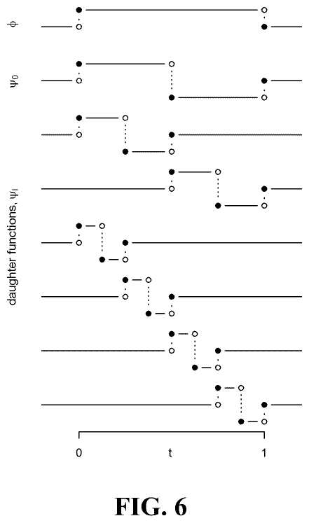

Referring again to FIG. 4, in the next step 108, the data set denoising computing device 12 performs an iteration of a Haar transform function, such as Haar transform 30 stored on memory 24, to the received data set, such as the diffraction pattern histogram illustrated in FIG. 5. The innermost dashed box (labelled A) including steps 108-112 in FIG. 4 illustrates one iteration of the Haar transform. Since histograms are piecewise constant functions, generally with constant bin widths, they are ideally suited for the Haar wavelet transform which is also piecewise constant with discontinuities at evenly spaced intervals. The Haar scale function, mother wavelet, and daughter wavelets are illustrated in FIG. 6. The solid lines denote constant function values, dotted lines denote function discontinuities, and open/filled symbols denote values that are excluded/included in the domain to establish a single-valued function of the independent variable, t. These functions constitute the basis set for the wavelet transform. While the scale function and mother wavelet span the full domain, the daughter functions are localized to progressively smaller portions of the domain for higher indices (i).

The measured intensity in a particular bin from a single analysis (Iᵢ) will be somewhat larger or smaller than the expectation value for that bin as calculated using Equation 1 due to Poisson noise. Thus, the measured intensities from a powder diffraction analysis {I₁, I₂, . . . , Iₙ} constitute a noisy histogram approximation to a continuous function, (ρ Δt Δ2θ).

In order to implement denoising using Haar wavelets, a diffraction pattern with measured intensities {I₁, I₂, . . . , Iₙ} corresponding to bins centered at Bragg angles {2θ₁, 2θ₂, . . . , 2θₙ} is considered. The step size Δ2θ=2θᵢ−2θᵢ₋₁ is assumed to be a constant for all indices i. Ideally, n is equal to an integer power of two (n=2^{p}). If not, then the intensity vector can be supplemented with zeros such that it is. To begin the Haar transform, in step 110, two vectors are created and output, each of length equal to half of n, to hold sums and differences of consecutive pairs of intensities as given by Equations (2) and (3) below:

$${S}^{1} = \{ ( {I}_{I} + {I}_{2} ) , ( {I}_{3} + {I}_{4} ) , … , ( {I}_{n - 1} + {I}_{n} ) \} \qquad ( 2 )$$

$${D}^{1} = \{ ( {I}_{I} - {I}_{2} ) , ( {I}_{3} - {I}_{4} ) , … , ( {I}_{n - 1} - {I}_{n} ) \} \qquad ( 3 )$$

The vectors in Equations (2) and (3) constitute the first iteration of an un-normalized Haar transform. The standard Haar transform includes a factor of ½^{1/2} in both the forward and reverse transform. Instead, the forward transform used here (Equations 2 and 3) are un-normalized and a factor of ½ is used in the reverse transform, as described in further detail below, in order to permit the forward transform to be accomplished using integer mathematics (Equations 2 and 3) and to simplify the hard thresholding rule as explained in the following paragraphs. In the next step, the data set denoising computing device 12 outputs the signal or sum (S) and difference or detail (D) vectors generated from the first iteration of the Haar transform.

The sum of two independent Poisson distributed variables is also Poisson distributed, with the mean of the sum equal to the sum of the independent component distributions as described in Haight, F. A. Handbook of the Poisson Distribution, New York, NY, USA: John Wiley & Sons, (1967), the disclosure of which is hereby incorporated by reference in its entirety. Therefore, the sum vector S, also called the averages vector, is itself a Poisson-distributed diffraction pattern with twice the step size and therefore half of the number of measurement bins as the original pattern. This interpretation of the sum vector as a diffraction pattern is another reason for using an un-normalized Haar transform. The difference vector D, also called the details vector, contains the additional information necessary to reconstruct the original pattern from the coarse-binned pattern (S), as described below.

Next, in step 112, the data set denoising computing device 12 applies a thresholding rule, such as the thresholding rule 32, to denoise the Haar transformed data set generated from the first iteration of the Haar transform. The measured intensities for each bin (Iᵢ) are assumed to be random variates drawn from a Poisson distribution, each with a different mean given by the expectation value for that bin (Equation 1). The variance (standard deviation squared) of the Poisson distribution is equal in magnitude to its expectation value. Therefore, the estimate for the variance of each bin's intensity is equal to the observed value of the intensity.

To determine if a particular difference value, Dᵢ, is statistically significant, it should be compared to the expectation value of its distribution under the null hypothesis that it is simply the result of noise. The difference between two Poisson distributed variables follows a Skellam distribution with variance also equal to the sum of the two Poisson distributed variables as describe in Skellam, J. G., “The frequency distribution of the difference between two Poisson variates belonging to different populations,” J. Royal Stat. Soc., 109(3), 296 (1946), the disclosure of which is hereby incorporated herein by reference it its entirety. Therefore, the sum value, Sᵢ, provides the necessary variance estimate to evaluate the corresponding difference value with minimal additional computational overhead. Specifically, if −s≤Dᵢ/(Sᵢ)^{1/2}≤s then the difference is within s standard deviations of zero and therefore not distinguishable from Poisson noise. Equivalently, if Dᵢ²≤s²Sᵢ then the difference Dᵢ is within s standard deviations of zero. Small differences are not statistically significant and may be set to zero while larger differences are statistically significant and must be retained. Thus, the hard thresholding rule for Haar denoising of histogram data with Poisson noise is given by Equation (4), below:

$${D}_{i} = \{ \begin{matrix}0 & if {D}_{i}^{2} \leq {s}^{2} {S}_{i} \\ unchanged & otherwise\end{matrix} . \qquad ( 4 )$$

The necessary sums and differences between successive bins for computing the Haar wavelet transform (Equations 2 and 3) are numerically efficient and permit a simple hard thresholding rule specific for Poisson noise (Equation 4) with minimal overhead.

Setting an element of the detail vector to zero is equivalent to setting the intensity of two consecutive bins to their average value, or equivalently to locally doubling the step size when the intensities of consecutive bins do not differ by a statistically significant quantity. For data with localized peaks, many of the coefficients can be set to zero which can also be used for data compression as described in Walker, J. S., A Primer on Wavelets and Their Scientific Applications (Studies in Advanced Mathematics) 2^{nd} ed, Chapman and Hall/CRC (2008), the disclosure of which is hereby incorporated herein by reference in its entirety.

Equation (4) is a hard thresholding rule for differences (Dᵢ) that depends on the magnitude of the signal in the corresponding bin (Sᵢ) which is appropriate for signals with Poisson noise that is inherently heteroskedastic. It is an alternative to other choices, such as the widely used rule disclosed in Donoho, D. L., “Ideal spatial adaptation via wavelet shrinkage,” Biometrika. 81(3):425-455 (1994), for choosing a uniform threshold which is based on an assumption of noise with a constant standard deviation throughout the data set.

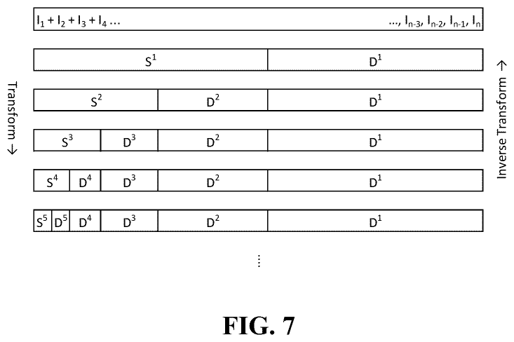

Next, in step 114, the data set denoising computing device 12 determines if the sum vector has a length equal to 1. If yes, the Y branch is taken and the method continues. If no, the N branch is taken and additional recursive Haar transform iterations are applied using the steps 108-112 in dashed box A, each contracting the length of the sum vector by a factor of two, until the sum vector has a length equal to 1. The dashed box labelled B in FIG. 4 illustrates a number of iterations of Haar transforms as well as the reverse Haar transform. Since the sum vector, S, is itself a diffraction pattern with Poisson noise, the process may be iterated yielding sum and difference vectors of half the length of the previous iteration, as illustrated in FIG. 7. The cascade algorithm continues until the sum vector is a single integer whose value is the total number of counts in the original pattern and there are a set of vectors D, each of a different power-of-two length, containing the information needed to reconstruct the diffraction pattern for the previous iteration. This vector contains the coefficients of the basis functions illustrated in FIG. 6. Decomposition of the original signal (top row of FIG. 7) into a set of detail vectors (Dⁱ) of different lengths (bottom row of FIG. 7) is called multiresolution analysis. For n=2^{p} bins, the process continues for p iterations until SP is a scalar equal to the sum of the original intensities (ΣIᵢ) which is the coefficient of the scale function, D^{p} is the scalar coefficient of the mother function, and the other detail vectors Dⁱ are coefficients of scaled and shifted daughter functions illustrated in FIG. 6.

Next, in step 116, the data set denoising computing device 12 applies a reverse Haar transform for each of the Haar transform iterations to generate the denoised data set. Applying the thresholding rule during the forward transform followed by the reverse transformation yields an efficient and effective denoising method.

The forward transformation (Equations 2 and 3) involves only sums and differences of integers and therefore may be performed using integer arithmetic. The reverse transform, as given by Equation (5) below, may yield fractional results due to the necessary divisions by two to recover the denoised diffraction pattern for each iteration,

$$\{ ( {S}_{1} + {D}_{1} ) / 2 , ( {S}_{1} - {D}_{1} ) / 2 , ( {S}_{2} + {D}_{2} ) / 2 , ( {S}_{2} - {D}_{2} ) / 2 , … ( {S}_{n} + {D}_{n} ) / 2 , ( {S}_{n} - {D}_{n} ) / 2 \} \qquad ( 5 )$$

The subscripts in Equation (5) refer to elements within the vectors S and D and are not to be confused with superscripts in Equations (2) and (3) which refer to different iterations of the algorithm. With careful memory management the entire process can be done in place. Alternatively, if auxiliary storage of two vectors each of length equal to one-half that of the original pattern is available to store S and D during their generation, then the result can overwrite the original data as illustrated in FIG. 7. This is a somewhat simpler, but less efficient algorithm than the in-place alternative. In yet another alternative, the data set denoising data can keep all of the data generated by the various Haar transform iterations. This is a less computationally efficient method. In this example, the thresholding can be performed after all of the Haar transform iterations are complete instead of after each iteration as required for the memory management methods described above.

The outermost dashed box labelled C in FIG. 4 illustrates a cycle-spun Haar/Poisson denoising composed of j transform iterations (where j is the length of the longest plateau after the first iteration. The cycle-spun method is described in further detail with respect to the example set forth below.

In some examples, the method may proceed directly to step 132 with the cycle-spun Haar/Poisson denoising. In step 132, the data set denoising computing device 12 can provide the denoised data set of length n (truncating any appended zeros) for display on a user interface, such as on one of the client devices 16(1)-16(n) shown in FIG. 2, for example. The techniques described herein are useful for optimizing the appearance of a data set, such as a diffraction pattern. The denoising methods described here are useful, for example, for data presentation, including identifying statistically significant peaks.

### Denoising of Two-Dimensional Data

The denoising method could also be employed for two-dimensional (e.g., image) data. Consider a 2^{p} by 2^{p} array of measured values, each comprised of a signal and Poisson noise. If the array is not square and/or the number of bins along each axis is not an integer power of two, zeros can be appended as needed.

Consider a representative 2 by 2 block of values:

| | |
|---|---|
| I_{i, j+1} | l_{i+1, j+1} |
| l_{i, j} | l_{i+1, j} |

A two-dimensional transform can be applied as follows:

$$h = ( {I}_{i , j} + {I}_{i + 1 , j} ) - ( {I}_{i , j + 1} + {I}_{i + 1 , j + 1} )$$

$$d = ( {I}_{i + 1 , j + 1} + {I}_{i , j} ) - ( {I}_{1 , j + 1} + {I}_{i + 1 , j} )$$

$$a = {I}_{i , j + 1} + {I}_{i + 1 , j + 1} + {I}_{i , j} + {I}_{i + 1 , j}$$

$$v = ( {I}_{i + 1 , j + 1} + {I}_{i , j} ) - ( {I}_{i , j + 1} + {I}_{i + 1 , j} )$$

Since a is the sum of Poisson-distributed variables, it is also Poisson-distributed and therefore the algorithm can be iterated. The remaining values (h, d, and v) are the difference between two sums in parentheses. The sums are Poisson-distributed and the differences are Skellam-distributed with each variance approximately equal to a. Therefore, the values (h, d, and v) may be safely set to zero if:

$${( h , d , or v )}^{2} < {s}^{2} a$$

which is equivalent to the thresholding rule (Equation 4) discussed above.

At each stage of the recursive algorithm the number of bins contracts by a factor of two in both directions. Following the wavelet transform, the inverse transform is as follows:

$${I}_{i , j} = ( h + d + a + v ) / 4$$

$${I}_{i + 1 , j} = ( h - d + a - v ) / 4$$

$${I}_{i , j + 1} = ( - h - d + a - v ) / 4$$

$${I}_{i + 1 , j + 1} = ( - h + d + a + v ) / 4$$

Since the differences (h, d, and v) are differences between pairs of Poisson-distributed values rather than single values, the recommended minimum value for image denoising is 25 counts rather than 50 counts for pattern denoising, although other counts may be employed.

In this example, the forward wavelet transform is accomplished using integer addition and subtraction, application of the thresholding rule requires squaring of integers and multiplication by s², and the inverse wavelet transform involves integer addition and subtraction followed by division by four (rather than two for pattern denoising). These operations are each analogous to the pattern denoising case. Cycle spinning requires offsets in the horizontal, vertical, and diagonal directions according to the longest plateau in each direction.

### EXAMPLES

### Example 1—Denoising Simulated Data

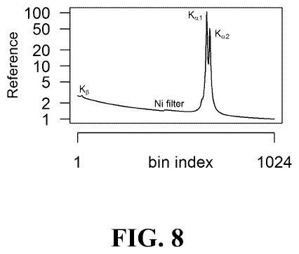

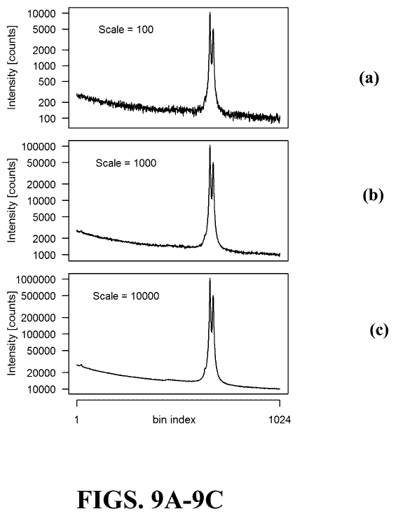

In order to test the effectiveness of the denoising method disclosed herein, a test pattern was constructed as illustrated in FIG. 8. The pattern includes Cu K_{α1}, K_{α2}, and K_{β} peaks and a step in the background typical of Ni foil monochromators. The test pattern is shown on a semi-logarithmic plot to accommodate the large dynamic range. The pattern contains n=1024=2¹⁰ bins and is motivated by the source spectrum for a laboratory X-ray source with a foil monochromator. In order to study the effect of counting time, the test pattern is multiplied by a scale factor greater than unity, then Poisson noise is added to each bin in the pattern using the RPOIS function in the STATS package of the R programming language (R, 2023) which implements the Ahrens and Dieter method for generating Poisson deviates as disclosed in Ahrens, J. H., “Computer generation of Poisson deviates from modified normal distributions,” ACM Transactions on Mathematical Software, 8, 163-179 (1982), the disclosure of which is hereby incorporated by reference herein in its entirety. The resulting synthetic patterns are illustrated for three scale factor values in FIGS. 9A-9C. The patterns are displayed on semi-logarithmic axes to accommodate the large dynamic range. Note that the total number of counts in the patterns increases in proportion with the scale factor. Since the magnitude of the Poisson noise increases with the square-root of the counts in each bin, the absolute magnitude of the noise increases, but the signal-to-noise ratio increases with increased values of the scale factor.

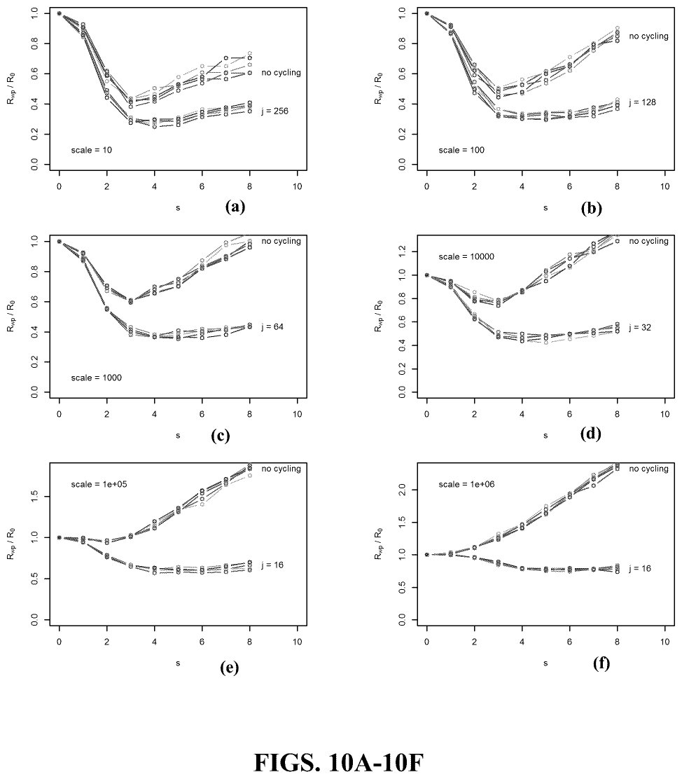

FIGS. 10A-10F present weighted-pattern residual (R_{wp}) values computed using the difference between the (known) scaled test pattern (I₀) and the denoised pattern (I), as disclosed in Toby, B. H., “R factors in Rietveld analysis: How good is good enough?” Powder Diffraction, 21(1), 67-70 (2006), the disclosure of which is hereby incorporated by reference herein in its entirety.

$${R}_{wp} = {[ \frac{\sum {( I - {I}_{0} )}^{2} / {I}_{0}}{\sum {I}_{0}} ]}^{1 / 2} \qquad ( 6 )$$

as a function of the thresholding parameter(s) for six values of the scale factor and five independent iterations of the synthetic noise for each (colored curves). For s=0 the denoising process is fully reversible and the resulting pattern is the same as the input. For small but finite s values, the denoising process reduces the residual value by reducing noise. Without cycle spinning there is a particular value (s˜3 in this case) that minimizes the residual. For the illustrated examples, the cycle spinning depth (j) is based on the initial pass. Cycle spinning improves the resulting pattern (lower R_{wp} value) and produces a broader minimum (less sensitive to s value). Good results are found for s=4 with cycle spinning for a wide range of scale factors and random noise repetitions.

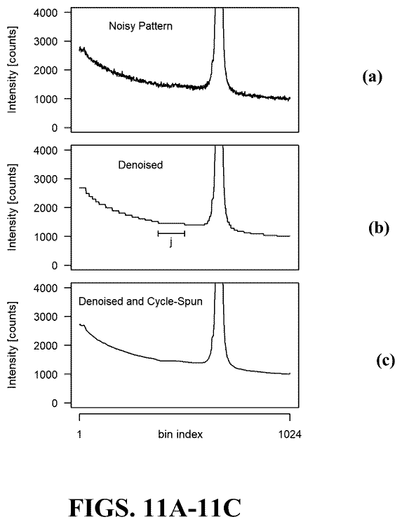

FIGS. 11A-11C shows cycle spinning results for scale=1000. The results are shown on linear axes and truncated to emphasize the impact on the background portion of the test pattern. FIG. 11A illustrates the original noisy pattern. FIG. 11B illustrates the denoised pattern according to the methods of the present disclosure. Larger values of s turn a gently sloping background into a stairstep pattern as shown in FIG. 11B. This causes the residual to increase for large s values. The discontinuities in the denoised pattern occur primarily at bin indices that are integer multiples of powers of two as a result of the lack of translational invariance of the wavelet transform. This tendency to create stairsteps can be minimized using cycle spinning, as disclosed in Coifman, R. R. “Lecture Notes in Statistics”, 103, 125-50 (1995), the disclosure of which is incorporated by referenced herein in its entirety.

As shown in FIG. 4, cycle spinning involves repetitions of the denoising process using data that have been cyclically shifted, denoised, and shifted back to the original registry as shown in steps 120-130 of FIG. 4. The results of repetitions with different shifts are then averaged. While this could be done for all n−1 possible shifts, it is generally found that a smaller number of shifts are sufficient. The number of shifted data sets to be averaged is called the spin-cycling depth and denoted as j here. Good results are found for a cycle spinning depth equal to the length of the longest plateau (constant value) in the initial (first iteration) denoised pattern, ignoring any padded zeros needed to produce a power-of-two vector length. FIG. 11C illustrates the denoised and cycle spun pattern. FIG. 11C shows an example of denoising using spin-cycling with depth of 64 which is the number of bins in the longest plateau in the middle panel. With cycle spinning, the residual value is found to have a broad minimum with respect to the thresholding variable(s) such that choosing s=4 is nearly optimal as shown in FIGS. 10A-10F.

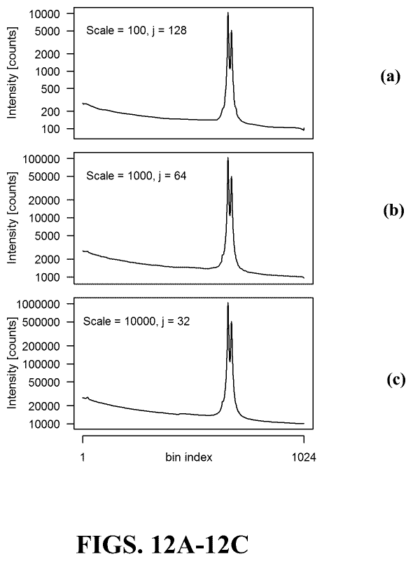

The results of denoising and cycle spinning the test patterns depicted in FIGS. 9A-9C are shown in FIGS. 12A-12C. The K_{α1} and K_{α2} peaks and the background are similar in all three results. The K_{β} peak is evident in the results for the larger two scales while the foil monochromator step feature is evident only for the largest scale. Since the scale factor is analogous to the counting time in a diffraction experiment, the pattern for the largest scale factor (FIG. 12C) would have required 100 times as long for data acquisition as for the smallest scale factor (FIG. 12A).

Denoising is not able to recover features whose intensities are much smaller than the Poisson noise in the patterns but is able to accurately remove noise from stronger features, even with relatively short data acquisition times. Longer data acquisition times may still be warranted if weak features such as impurity peaks are of interest, however.

Since the hard thresholding rule (Equation 4, above) impacts only the difference vectors, the sum vectors are preserved. Therefore, the algorithm conserves the integrated intensity of the data. Put another way, the sum of the counts in each of the bins is precisely the same in the initial data as in the denoised pattern. Since cycle spinning averages patterns with the same intensity, it also conserves total counts. For example, the total intensity of the pattern illustrated in FIGS. 11A-11C is precisely 2,503,097 counts in the initial pattern (FIG. 11A), following the first denoising cycle (FIG. 11B), and following spin-cycling (FIG. 11C).

The denoising method disclosed is very efficient. For a data set of length n=2^{p}, Haar transformation requires (2n) addition and subtraction operations (Equations 2 and 3), hard thresholding requires (2n+1) multiplications (Equation 4) assuming that s² is calculated once, and the reverse transform requires (2n) addition and subtraction operations and (2n) divisions by two (Equation 5). Thus, the computational time needed for pattern denoising scales linearly with the vector length (n). If the thresholding parameter s is set to four, then multiplication by s²=16 in Equation 4 can be efficiently accomplished by left-shifting of the binary representation of the integer Sᵢ or by adding a constant to the exponent if floating point values are used. If a different threshold value is desired, then choosing a value such that s² is an integer is recommended to maintain integer arithmetic during the forward transform with thresholding portion of the algorithm. Division by two can be accomplished in Equation 5 using a right-shifting of the binary representation of the integer sums and differences if truncation is acceptable or subtracting a constant from the exponent if floating point values are used.

Cycle spinning increases the coefficient of the computational scaling through repetition but does not change the scaling with respect to vector length (n). Averaging of multiple iterations requires floating point values for the result vector. Patterns with smaller numbers of counts per bin are relatively noisier, tend to have longer plateaus following the first denoising iteration, and thus require greater cycle spinning depths. Therefore, data from longer acquisition time experiments with larger counts in each bin is denoised faster, all other things being equal.

### Example 2—Denoising Experimental Data

The disclosed denoising method was applied to experimental diffraction data for three samples including one crystalline inorganic material, one crystalline organic material, and an x-ray amorphous material.

### A. Alpha Alumina

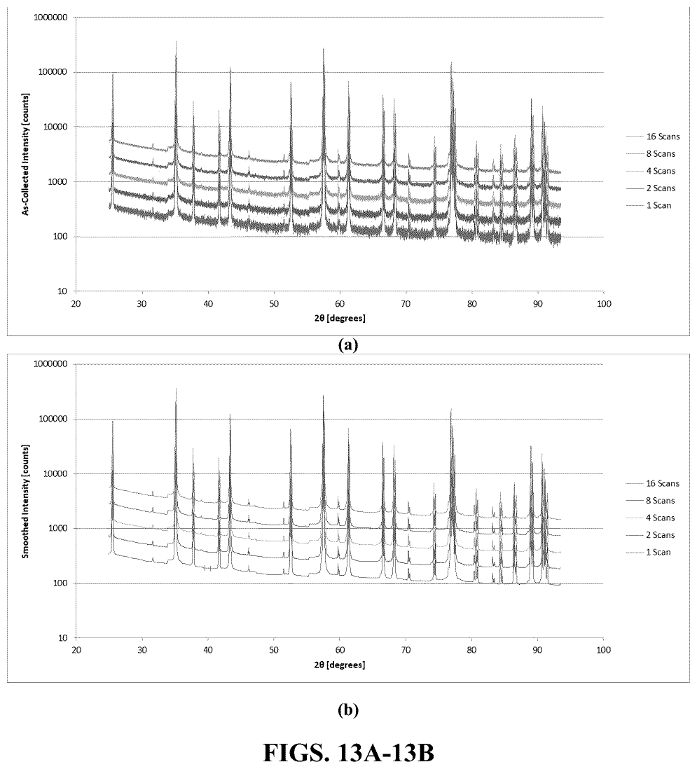

FIG. 13A presents experimental data collected on a monolithic specimen of alpha alumina, NIST SRM 1976b, as disclosed in Black, D., “Certification of Standard Reference Material 1976B,” Powder Diffraction, 30(3), 199-204 (2015), the disclosure of which is hereby incorporated herein by reference in its entirety. The data was collected using a Panalytical X'Pert Pro MPD diffractometer operated in Bragg-Brentano geometry. A total of 16 successive scans were collected for approximately 1 hour each. The source data was collected for a wider range, but a subset with n=16,384=2¹⁴ bins for 25°<2θ<93.45° is shown in FIG. 13A. From bottom to top, the five patterns are of a single scan, the sum of two independent scans, the sum of four independent scans, the sum of eight independent scans, and the sum of all sixteen scans. By summing scans as described, the signal increases by a factor of two for successive patterns while the noise increases by a factor of 2^{1/2}. Thus, the signal-to-noise ratio improves by a factor of 2^{1/2} for successive patterns. On a semi-logarithmic plot the patterns are shifted vertically, the shape of the signal is preserved, and the signal-to-noise improves for increasing numbers of summed scans.

FIG. 13B shows the results of the same five patterns as in FIG. 13A but following denoising with cycle spinning. The same threshold parameter value, s=4, was used for all five patterns. It is evident that positions and shapes of features are preserved. This includes reflections with resolved Cu K_{α1}, K_{α2}, and K_{β} contributions as well as steps in the background as the result of a Ni foil monochromator most easily seen near 33.4° and 54.6° 2θ. Most of the Poisson noise has been eliminated, but there are a small number of cases in which the noise was not fully eliminated. For the single scan, two such cases are seen near 38.8° and 39.6° 2θ where there are pairs of consecutive bins with positive and negative residuals that are not seen for the multiple scan patterns. This is the result of successive bins with noise of large magnitude and opposite signs in the as-collected data. Careful inspection of all five results shows a few additional cases of the same phenomenon in the other denoised patterns. Each of them can be eliminated using a larger value of the denoising parameter, s²=20, for instance. Also, there are a few instances of very weak KB peaks that are evident in the multiple scan patterns, but not in the single scan pattern. With these very minor exceptions, the similarity of the resulting patterns is evident. Denoising has successfully preserved the signals in the patterns and dramatically reduced noise. The single scan pattern requires only 1/16 of the instrumental time for collection relative to the sum of all 16 scans, but once it has been denoised the result is nearly the same as the denoised patterns of multiple scans and less noisy than even the sum of all sixteen scans without denoising.

Although the intent of the disclosed method is denoising, wavelet transforms without spin cycling can also be used for signal compression. The fraction of elements set to zero in the thresholding step ranges from 94.5% for the single scan pattern to 89.2% for the sixteen scan pattern prior to cycle spinning. Thus, a compression ratio of 10:1 to 20:1 is possible for this data. The higher value is associated with the stair-step appearance of the single step result. Cycle spinning reduces the appearance of the discontinuities, but also eliminates the repeated values that facilitate compression. Since modern computers have more than adequate storage for diffraction patterns, there is little need for compression when working with single patterns. Compression may be useful for databases with huge numbers of experimental data sets, or for high frequency data collection.

### B. Mannitol Form Beta

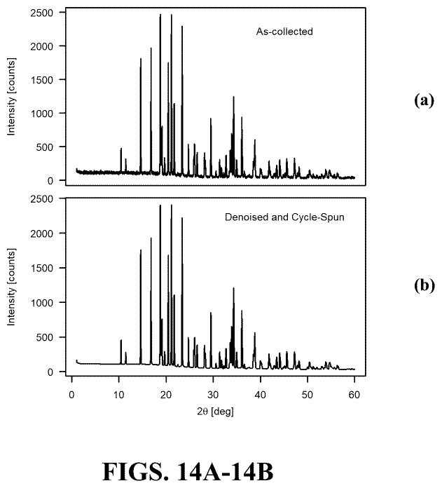

FIG. 14A presents experimental data collected on a powder specimen of mannitol form beta (ACS Reagent Grade D-mannitol from Sigma-Aldrich, Lot 094K0047) using a Panalytical X'Pert Pro MPD diffractometer operated in transmission geometry. The pattern was collected with 7,061 bins for 1°<2θ<60°. Collection time was approximately 10 min for the entire pattern. The data was padded with zeros to yield a vector of length n=8,192=2¹³ bins prior to denoising. The mannitol example is included to illustrate application of the denoising method disclosed herein to a diffraction pattern for a crystalline organic material using a short collection time in contrast with the alpha alumina NIST standard collected over 16 hours in the previous example.

FIG. 14B shows that the pattern has been successfully denoised without degrading the peaks in the pattern. Similar to the previous example, 90.6% of the difference elements were set to zero in the transformation. The cycle spinning depth for this example is 512. The large value is due to the relatively flat portion of the background below 10° 2θ and the short duration analysis.

### C. Lyophilized Trehalose

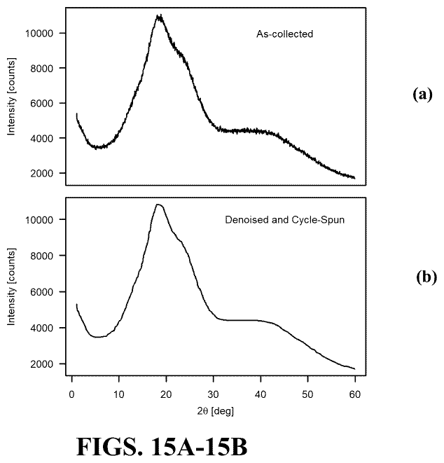

FIG. 15A presents experimental data collected on a powder specimen of lyophilized trehalose (HPLC grade trehalose dehydrate from Fluka, lot 1235301, lyophilized from aqueous solution using a Flexi-Dri lyophilizer) using a Panalytical X'Pert Pro MPD diffractometer operated in transmission geometry. The pattern was collected with 1,177 bins for 1°<2θ<60°. Collection time was approximately 32 min. The data was padded with zeros to yield a vector of length n=2,048=2¹¹ bins prior to denoising. This example is included to demonstrate application of the denoising method disclosed herein to a pattern for an X-ray amorphous material.

FIG. 15B shows that the pattern has been successfully denoised. 92.4% of the difference elements were set to zero in the transformation, which is similar to the patterns of crystalline materials. Apparently, the permissible compression ratio of diffraction patterns is not strongly dependent on the crystallinity of the sample. The cycle spinning depth for this example is 128. The longest plateau, which determines the cycle spinning depth, is associated with the relatively flat region near 35° 2θ.

The same thresholding parameter (s=4) was used for the examples shown in FIGS. 13, 14, and 15. This illustrates that the thresholding parameter is not dependent upon the qualitative features in the patterns (sharp peaks, broader peaks, and amorphous halos, respectively). The spin cycling depth (j) varied among the three examples but was set equal to the longest plateau length after the first iteration in each case. This parameter independence ensures that patterns may be denoised without manual intervention.

While the disclosed denoising method is described and illustrated for X-ray diffraction, it may also be applied to diffraction using other discrete probes such as electron or neutron diffraction. In the examples, patterns are illustrated as functions of the Bragg angle, 2θ. Other independent variables, such as the scattering vector magnitude (q=4π sin (θ)/2) may be used as long as the bin widths (Δq) are consistent.

For a fixed total analysis time and scan range, the best denoising results are generated using small step sizes to improve peak resolution as long as the minimum number of counts per bin is sufficient for the sum of consecutive bin counts (Sᵢ) to be a good estimate of the variance of the Skellam distribution for the difference (Dᵢ) in the hard thresholding expression (Equation 4). As a rule of thumb, at least 50 counts per bin are recommended prior to denoising. Greater counts may be necessary if evidence for very weak peaks is desired. The associated increase in cycle spinning depth for smaller step sizes is more than offset by the savings in data collection time through denoising.

This technology provides a numerically efficient denoising method that limits the computational time and power required. Position and shapes of features in the data set are preserved. The method further preserves patterns in the signals and dramatically reduces noise. The method further reduces collection time of scans and can be used to optimize the appearance of a data set, such as diffraction pattern or two-dimensional image.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for generating a denoised data set from a data set comprising a signal and Poisson noise, the method comprising:
applying, by a data set denoising computing device, a Haar wavelet transform to the data set to generate a wavelet transformed data set comprising a plurality of sum values for consecutive pairs of intensities and a second data subset comprising a plurality of difference values for consecutive pairs of intensities;
denoising, by the data set denoising computing device, the wavelet transformed data set using a thresholding rule based on comparing each of the difference values to corresponding sum values, to determine if the difference values are statistically significant based on the corresponding sum values, to remove the Poisson noise from the signal; and
applying, by the data set denoising computing device, a reverse Haar wavelet transform to the denoised wavelet transformed data set to generate the denoised data set.

2. The method of claim 1, wherein the wavelet transformation is un-normalized.

3. The method of claim 1 further comprising:
applying, by the data set denoising computing device, the wavelet transform iteratively to a series of data sets based on the data set to generate a plurality of wavelet transformed data sets;
denoising, by the data set denoising computing device, each of the plurality of wavelet transformed data set using the thresholding rule; and
applying, by the data set denoising computing device, the reverse wavelet transform iteratively to each of the denoised wavelet transformed data sets to generate the denoised data set.

4. The method of claim 3 further comprising:
applying, by the data denoising computing device, a cycle spinning process to form the denoised data set.

5. The method of claim 4, wherein a depth of the cycle spinning is based on a longest plateau length after a first iteration.

6. The method of claim 1 further comprising:
providing, by the data set denoising computing device, the denoised data set for display on a user interface.

7. The method of claim 1, wherein the denoising comprises comparing an absolute value of the difference value to a square root of the corresponding sum value.

8. The method of claim 7, wherein the thresholding rule is a hard thresholding rule.

9. The method of claim 7, wherein the thresholding rule is a soft thresholding rule.

10. The method of claim 1, wherein the denoising comprises comparing a square of the difference value to the corresponding sum value.

11. The method of claim 10, wherein the thresholding rule is a hard thresholding rule.

12. The method of claim 10, wherein the thresholding rule is a soft thresholding rule.

13. The method of claim 1, wherein the signal comprises a powder diffraction pattern.

14. The method of claim 13, wherein the powder diffraction pattern is an x-ray, neutron, or electron diffraction pattern.

15. The method of claim 1, wherein the signal comprises two-dimensional image data.

16. A data set denoising computing device, comprising memory comprising programmed instructions stored thereon and one or more processors configured to execute the stored programmed instructions to:
apply a Haar wavelet transform to the data set to generate a wavelet transformed data set comprising a plurality of sum values for consecutive pairs of intensities and a second data subset comprising a plurality of difference values for consecutive pairs of intensities;
denoise the wavelet transformed data set using a thresholding rule based on comparing each of the difference values to corresponding sum values, to determine if the difference values are statistically significant based on the corresponding sum values, to remove the Poisson noise from the signal; and
apply a reverse Haar wavelet transform to the denoised wavelet transformed data set to generate the denoised data set.

17. The data denoising computing device of claim 16, wherein the memory further comprises additional programmed instructions stored thereon that when executed by the one or more processors cause the one or more processors to:
apply the wavelet transform iteratively to a series of data sets based on the data set to generate a plurality of wavelet transformed data sets;
denoise each of the plurality of wavelet transformed data set using the thresholding rule; and
apply the reverse wavelet transform iteratively to each of the denoised wavelet transformed data sets to generate the denoised data set.

18. The data denoising computing device of claim 17, wherein the memory further comprises additional programmed instructions stored thereon that when executed by the one or more processors cause the one or more processors to:
apply a cycle spinning process to form the denoised data set.

19. The data denoising computing device of claim 17, wherein the memory further comprises additional programmed instructions stored thereon that when executed by the one or more processors cause the one or more processors to:
provide the denoised data set for display on a user interface.

20. A non-transitory computer readable medium having stored thereon instructions for denoising a data set comprising executable code that, when executed by one or more processors, causes the processors to:
apply a Haar wavelet transform to the data set to generate a wavelet transformed data set comprising a plurality of sum values for consecutive pairs of intensities and a second data subset comprising a plurality of difference values for consecutive pairs of intensities;
denoise the wavelet transformed data set using a thresholding rule based on comparing each of the difference values to corresponding sum values, to determine if the difference values are statistically significant based on the corresponding sum values, to remove the Poisson noise from the signal; and
apply a reverse Haar wavelet transform to the denoised wavelet transformed data set to generate the denoised data set.
